(19) United States
(12) Patent Application Publication
(10) Pub. No.: US 2009/0271814 A1
(43) Pub. Date: Oct. 29, 2009

(54) METHOD AND SYSTEM FOR ACTIVATING A DECODER DEVICE

(75) Inventor: Albert Jan Bosscha, Hoofddorp (NL)

Correspondence Address: SCHWEGMAN, LUNDBERG & WOESSNER, P.A., P.O. BOX 2938, MINNEAPOLIS, MN, 55402, US

(73) Assignee: Irdeto Access B.V., Hoofddorp (NL)

(21) Appl. No.: 12/430,218

(22) Filed: Apr. 27, 2009

(30) Foreign Application Priority Data
Apr. 25, 2008 (EP) 08155213.5

(51) Int. Cl. H04N 7/16

(52) U.S. Cl. 725/25

(57) ABSTRACT

Various embodiments of the invention provide a method for activating one or more secondary decoder devices in a home network. A head-end system activates a primary decoder device and initializes the secondary decoder devices. The primary decoder device activates the initialized secondary decoder device. The secondary decoder device is deactivated upon expiration of a timer value until reactivated by the primary decoder device.

### CLAIM OF PRIORITY

The present patent application claims the priority benefit of the filing date of European Application (EPO) No. 08155213.5 filed Apr. 25, 2008, the entire content of which is incorporated herein by reference in its entirety.

### FIELD OF THE INVENTION

The present invention relates to a method for activating one or more secondary decoder devices, a head-end system for activating one or more secondary decoder devices, a secondary smartcard and a decoder device.

### BACKGROUND

Conditional access systems are generally used to pro-vide conditional access to services like pay TV. In a conditional access system, scrambled TV signals are transmitted from a head-end system to a decoder device. An end-user of the pay TV service inserts a smartcard in the decoder device to conditionally enable descrambling of the scrambled TV signal. The smartcard receives entitlement management messages (EMM) from the head-end system with authorization information. If the end-user is authorised, e.g. because he has a valid subscription, encrypted entitlement control messages (ECM) sent from the head-end system to the smartcard are decrypted in the smartcard. Hereby control words (CW) are retrieved from the ECMs. The CWs are transmitted to the decoder device, where the CWs are used to descramble the scrambled TV signals. The descrambled TV signals are viewable on a terminal like a television, a PC or a mobile phone, or can be recorded on a video recorder.

A decoder device with inserted smartcard typically allows only one terminal to be connected. Consequently each terminal requires a dedicated decoder device and smartcard to enable descrambling of the scrambled TV signal. For each smartcard an authorisation is required to enable decrypting of ECMs in the smartcard. This means that an end-user having e.g. two televisions requires two subscriptions, one for each smartcard.

Each smartcard operates as a stand alone smartcard. With a change in the authorisation of an end-user, each smartcard receives an EMM to update the authorization of the smartcard. E.g. when an end-user with multiple decoder devices subscribes to a pay TV service, each smartcard intended for use in the decoder devices receives an EMM to enable decrypting ECMs to thereby effectively activate descrambling the TV signals in the decoder device.

### SUMMARY OF THE INVENTION

It is an object of the invention to provide an improved method and system for activating one or more secondary decoder devices.

According to an aspect of the invention a method is provided for activating one or more secondary decoder devices. The method is used in a system comprising a head-end system, a primary decoder device and the one or more secondary decoder devices. The head-end system is communicatively connected to the primary decoder device and to the one or more secondary decoder devices. The method comprises the step of the head-end system activating the primary decoder device. The method further comprises the step of the head-end system initializing the secondary decoder device. The method further comprises the step of the primary decoder device activating the initialized secondary decoder device. The primary decoder device comprises a primary interface configured for communication with a primary smartcard and the secondary decoder device comprises a secondary interface configured for communication with a secondary smartcard. The method further comprises the step of receiving in the primary smartcard an activation message from the head-end system. The method further comprises the step of creating in the primary smartcard first activation data using the activation message. The method further comprises the step of providing the first activation data via the primary interface to the primary decoder device. The method further comprises the step of activating the primary decoder device using the first activation data. The method further comprises the step of receiving in the secondary smartcard an initialization message from the head-end system. The method further comprises the step of creating in the secondary smartcard initialization data using the initialization message. The method further comprises the step of providing the initialization data via the secondary interface to the secondary decoder device. The method further comprises the step of initializing the secondary decoder device using the initialization data. The method further comprises the step of creating in the primary smartcard second activation data. The method further comprises the step of providing the second activation data via the first interface to the primary decoder device. The method further comprises the step of providing the second activation data from the primary decoder device to the secondary smartcard. The method further comprises the step of providing the second activation data from the secondary smartcard via the secondary interface to the secondary decoder device. The method further comprises the step of and activating the secondary decoder device using the second activation data. The primary smartcard further comprises a first timer. The method further comprises the step of setting the first timer using a first timer value comprised in the activation message. The method further comprises the step of activating the first timer. The method further comprises the step of upon expiration of the first timer value providing renewed second activation data from the primary decoder device to the secondary smartcard.

Thus the method of the invention advantageously enables the head-end system to control which decoder devices may be used to descramble e.g. a scrambled TV signal by activating a primary decoder device and initializing one or more secondary decoder devices, which primary decoder device controls the activation of the secondary decoder devices. The primary decoder device and secondary decoder devices are typically located at the premises of an end-user and are typically used to descramble a pay TV signal for viewing and/or recording on terminals connected to the decoder devices. Advantageously an end-user can use secondary decoder devices without requiring stand alone subscriptions for each secondary decoder device. Instead a subscription can be linked to the primary decoder device, while for the secondary decoder devices the subscriptions are offered at e.g. a reduced rate. The invention advantageously enables activation of the primary decoder device and initialization and activation of the second decoder device by using smartcards. When using smartcards, the subscriptions are typically linked to the smartcards. Typically the primary smartcard and secondary smartcard are physically identical. A smartcard becomes a primary smartcard by receiving the activation message from the head-end system. A smartcard becomes a secondary smartcard by receiving the activation message from the primary decoder device. The timer advantageously enables the primary decoder device to reactivate the secondary decoder device under control of the head-end system.

The embodiments of claims 2 and 7 advantageously enable the second activation data, which is used to activate the secondary decoder device, to be placed on the secondary smartcard by inserting the secondary smartcard in the primary decoder device.

The embodiments of claims 3 and 8 advantageously enable the second activation data, which is used to activate the secondary decoder device, to be placed on the secondary smartcard by inserting the secondary smartcard in the secondary decoder device.

The embodiment of claim 4 advantageously enables the secondary decoder device to be deactivated and reactivated under control of the head-end system.

According to an aspect of the invention a head-end system is provided for activating one or more secondary decoder devices. The head-end system is used in a system comprising a head-end system, a primary decoder device and the one or more secondary decoder devices. The primary decoder device comprises a primary interface configured for communication with a primary smartcard. The secondary decoder device comprises a secondary interface configured for communication with a secondary smartcard. The head-end system is communicatively connected to the primary decoder device and to the one or more secondary decoder devices. The head-end system comprises an activation module configured for activating the primary decoder device by providing an activation message to the primary smartcard. The head-end system further comprises an initialization module configured for initializing the secondary decoder device by providing an initialization message to the secondary smartcard. The activation message comprises a first timer value for setting a first timer in the primary smartcard. The initialization message comprises a second timer value for setting a second timer in the secondary smartcard.

Thus the invention advantageously enables the head-end system to control which decoder devices may be used to descramble e.g. a scrambled TV signal by activating a primary decoder device and initializing one or more secondary decoder devices. The primary decoder device and secondary decoder devices are typically located at the premises of an end-user and are typically used to descramble a pay TV signal for viewing and/or recording on terminals connected to the decoder devices. Advantageously an end-user can use secondary decoder devices without requiring stand alone subscriptions for each secondary smart card. Instead a subscription can be linked to the primary smartcard, while for the secondary smart cards the subscriptions are offered at e.g. a reduced rate. The invention advantageously enables the head-end system to control the secondary decoder device for deactivation of the secondary decoder device and the primary decoder device for reactivation of the secondary decoder device.

According to an aspect of the invention a secondary smartcard is provided for use in a system comprising a head-end system, a primary decoder device and one or more secondary decoder devices. The primary decoder device comprises a primary interface configured for communication with a primary smartcard. The secondary decoder device comprises a secondary interface configured for communication with the secondary smartcard. The secondary smartcard comprises a receiver configured for receiving an initialization message from the head-end system. The receiver is further configured for receiving activation data from the primary smartcard via the intermediary of the primary decoder device. The secondary smartcard further comprises a processor configured for creating initialization data using the initialization message. The secondary smartcard further comprises a transmitter configured for providing the initialization data via the secondary interface to the secondary decoder device for initializing the secondary decoder device. The transmitter is further configured for providing the activation data via the secondary interface to the secondary decoder device for activating the secondary decoder device. The secondary smartcard further comprises a timer. The processor is further configured for setting the timer using a timer value comprised in the initialization message and for activating the timer. The secondary smartcard is configured for deactivating the secondary decoder device upon expiration of the second timer value until a renewed second activation data is received from the primary smartcard.

Thus the secondary smartcard of the invention advantageously enables initialization of the secondary decoder device under control of the head-end system and activation of the secondary decoder device under control of the primary decoder device.

### BRIEF DESCRIPTION OF THE DRAWINGS

Aspects of the invention will be explained in greater detail by reference to exemplary embodiments shown in the drawings, in which:

FIG. 1 shows a head-end system in a conditional access system of an exemplary embodiment of the invention;

FIG. 2a shows the steps of a method of an exemplary embodiment of the invention;

FIG. 2b shows the steps of a method of an exemplary embodiment of the invention;

FIG. 3a shows a secondary smartcard in a conditional access system of an exemplary embodiment of the invention;

FIG. 3b shows a secondary smartcard in a conditional access system of an exemplary embodiment of the invention;

FIG. 4 shows the steps of a method of an exemplary embodiment of the invention;

FIG. 5 shows the steps of a method of an exemplary embodiment of the invention; and

FIG. 6 shows the steps of a method of an exemplary embodiment of the invention.

### DETAILED DESCRIPTION

An end-user typically owns multiple terminals for viewing or recording TV signals. A first television and a video recorder are e.g. located in the living room, while a second television is located in a bedroom. To be able to watch and record scrambled pay-TV signals, decoder devices such as e.g. set-top boxes are connected to each television and video recorder. The set-top box connected to the first television operates as the primary decoder device. The set-top box connected to the video recorder and the set-top box connected to the second television operate as secondary decoder devices. It is possible to have any one of the set-top boxes operate as the primary decoder device, as long as there is only one primary set-top box defined in a group of decoder devices of the end-user. In the following examples the group of decoder devices is also called a home network.

The primary set-top box is activated by a head-end system of a service provider, while the secondary set-top boxes are initialized by the head-end system. After initialization, the secondary set-top boxes are activated by the primary set-top box. The set-top boxes are initialized and activated via the intermediary of smartcards, as will be described. Activation messages and initialization messages send from the head-end system are typically transmitted in entitlement management messages (EMMs).

When a primary or secondary set-top box is activated, it is ready to descramble scrambled TV signals. When activated, entitlement control messages (ECMs) received with the scrambled TV signals are decrypted by a smartcard, and control words obtained from the ECMs are passed from the smartcard to the descrambler of the set-top box. This enables the descrambler to descramble the scrambled TV signals. When a secondary set-top box is initialized, it is ready to receive activation data from the primary set-top box via the intermediary of a secondary smartcard. Without initialization, the secondary set-top box discards activation data received from the primary set-top box. Alternatively it is the secondary smartcard that discards the activation data, resulting in the secondary set-top box not being activated.

For each set-top box the end-user receives a smartcard, which is to be inserted into the set-top box to allow operation of the set-top box. The smartcard used in the primary decoder device becomes a primary smartcard upon receiving an activation message from the head-end system. Smartcards used in secondary decoder devices become secondary smartcards upon receiving an initiation message from the head-end system and/or receiving activation data from the primary decoder device.

Alternatively the smartcards are embed in the set-top boxes, e.g. as surface mounted devices (SMD).

The end-user pays a subscription fee for each smartcard to enable ECM processing by the smartcard. Smartcards sold to end-users are administered in a smartcard management module of the head-end system. The smartcard management module stores smartcard serial numbers and associates primary smartcards with secondary smartcards. To the primary smartcard a full subscription fee applies, while to the secondary smartcards a reduction in the subscription fee is applied.

To define the smartcards as primary or secondary, the end-user contacts the service provider. The end-user provides the smartcard serial numbers of each smartcard in the home network and indicates which smartcard is going to be used as the primary smartcard. The serial number of a smartcard can e.g. be printed on the smartcard, provided in a letter or presented to the end-user via the television when the smartcard is inserted into a set-top box. The smartcard management module records which smartcard is to operate as the primary smartcard and associates the serial numbers of the secondary smartcards with the primary smartcard. Alternatively the service provider predefines which smartcard is going to operate as primary smartcard and provides the end-user with the serial number of the predefined primary smartcard and serial numbers of the predefined secondary smartcards.

Initially, when the end-users buys the smartcards, the primary smartcard and secondary smartcards can be operationally identical, meaning that it is not yet defined which of the smartcards operates as primary smartcard or as secondary smartcard. Depending on how the smartcard is administered in the smartcard management module, the smartcard can become a primary smartcard when activated by the head-end system or a secondary smartcard when initialized by the head end-system and/or activated by the primary decoder device.

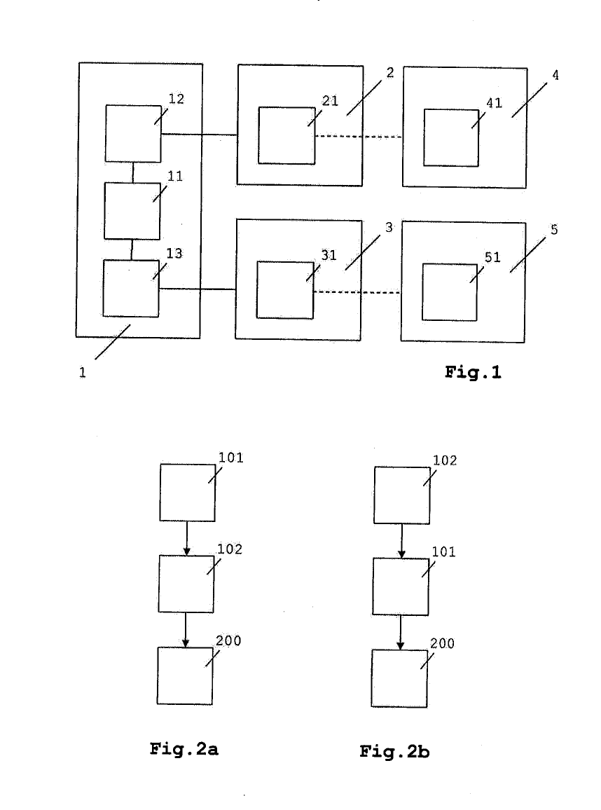

FIG. 1 shows head-end system 1 as part of a conditional access system of an exemplary embodiment of the invention. Head-end system 1 comprises the smartcard management module 11, an activation module 12 and an initialization module 13.

The smartcard management module 11 is used for storing the serial numbers of smartcards and for associating primary smartcards with secondary smartcards. A primary smartcard can e.g. be associated with a secondary smartcard by storing the corresponding serial numbers in a database and indicating in the database which serial number belongs to the smartcard operating as primary smartcard.

Head-end system 1 is communicatively linked to primary set-top box 2 and secondary set-top box 3. The link between head-end system 1 and set-top boxes 2 and 3 can comprise various intermediary links, such as wireless trajectories and/or wired trajectories between the head-end system and the home of the end-user, as well as wireless trajectories and/or wired trajectories within the home network. It is possible that the head-end system 1 is communicatively linked to the secondary set-top box 3 via the intermediary of the primary set-top box 2.

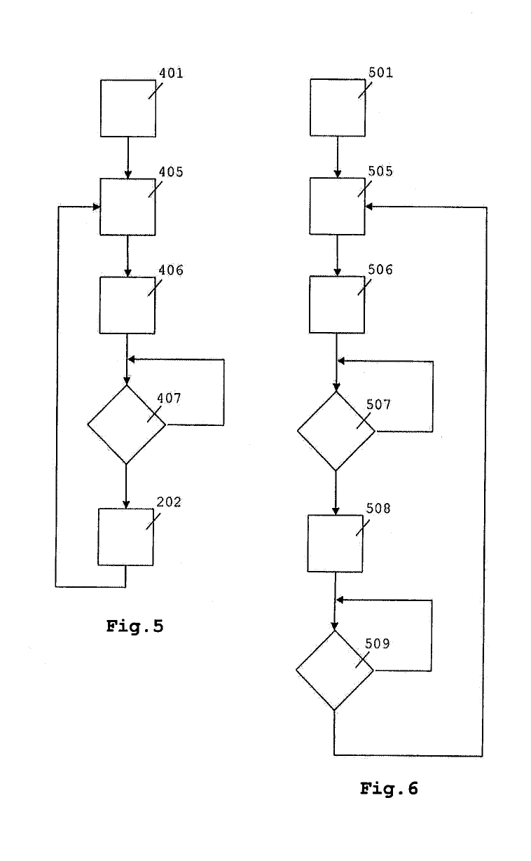

Primary smartcard 4 is used together with primary set-top box 2. Secondary smartcard 5 is used together with secondary set-top box 3. The smartcards 4 and 5 are e.g. credit-card sized smartcards, which are to be inserted in the set-top boxes for operation. The dashed line between set-top box and smartcard indicates that the smartcard is insertable in and removable from the set-top box. The primary set-top box 2 communicates with the primary smartcard 4 through primary interface 21. The secondary set-top box 3 communicated with the secondary smartcard 5 through secondary interface 31. Optionally the primary smartcard comprises a first timer 41 and the secondary smartcard 5 comprises a second timer 51. The function of the timers will be described in detail with FIG. 5 and FIG. 6.

The activation message in the form of an EMM message is transmitted from the activation module 12 to the primary smartcard 4 via the intermediary of primary set-top box 2 and primary interface 21. Using the activation message, the primary smartcard 4 creates first activation data and provides the activation data to the primary set-top box via the intermediary of the primary interface 21. With the first activation data the primary set-top box 2 is activated and ready to descramble scrambled TV signals. The activation message comprises the serial numbers of secondary smartcards in the home network. These serial numbers will be used to identify the secondary smartcards to be activated.

The initialization message in the form of an EMM message is transmitted from the initialization module 13 to the secondary smartcard 5 via the intermediary of secondary set-top box 3 and secondary interface 31. The secondary smartcard 5 creates initialization data and provides the initialization data to the secondary set-top box via the intermediary of the secondary interface 31. With the initialization data the secondary set-top box 3 is initialized and waiting to be activated. The initialization message comprises the serial number of the primary smartcard. This serial number will be used to identify the primary smartcard and accept activation data from the primary smartcard.

FIG. 2a shows the steps of activating one or more secondary set-top boxes 3 of an exemplary embodiment of the invention. In step 101 the head-end system 1 activates the primary set-top box 2. In step 102 the head-end system 1 initializes the secondary set-top box 3. The primary set-top box 2 activates the secondary set-top box 3 in step 200.

The order of activating 101 the primary set-top box 2 and initializing 102 the secondary set-top box 3 can alternatively be altered. This is illustrated in FIG. 2b.

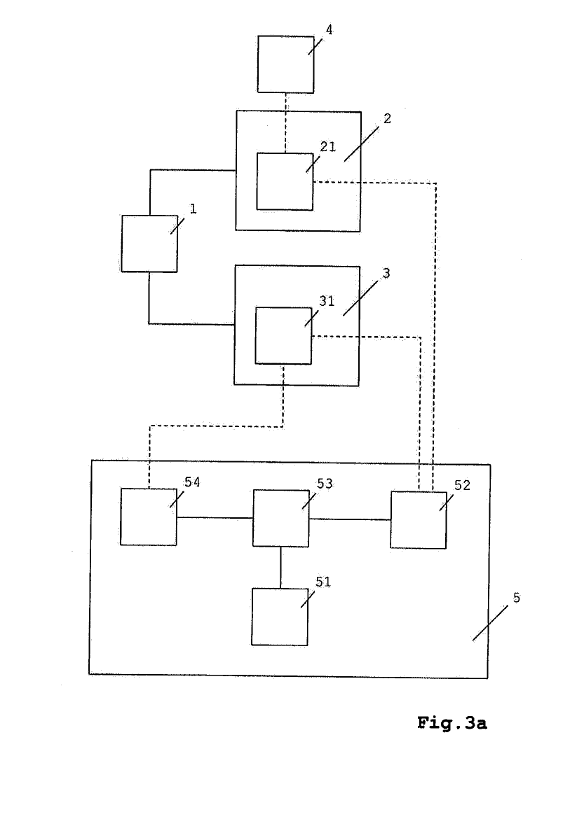

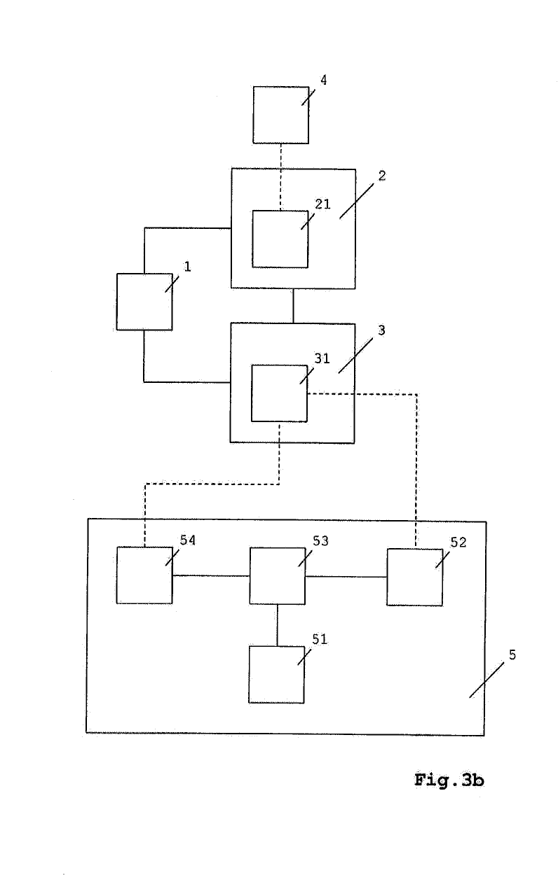

FIG. 3a shows a secondary smartcard 5 in a conditional access system of an exemplary embodiment of the invention. The dashed lines indicate non-permanent connections, i.e. the smartcards are insertable in and removable from the set-top boxes. In FIG. 3a the primary smartcard 4 is inserted in primary set-top box 2. Secondary smartcard 5 is insertable in both primary set-top box 2 and secondary set-top box 3.

In addition to FIG. 1, FIG. 3a shows in more detail the elements within the secondary smartcard 5 used for initialization and activation of the secondary set-top box 3. A processor 53 is connected to a receiver 52 and a transmitter 54. The processor is also connected to timer 51. The function of the timer 51 will be described in detail with FIG. 5 and FIG. 6.

To enable the secondary smartcard 5 to receive the initialization message from the head-end system 1, the secondary smartcard 5 is inserted into secondary set-top box 3. The initialization message is received in receiver 52 via the intermediary of the secondary interface 31. The processor 53 creates initialization data using the initialization message and via transmitter 54 the initialization data is provided to the secondary set-top box 3 via the intermediary of the secondary interface 31.

To activate the secondary set-top box 3, the secondary smartcard 5 is removed from the secondary set-top box 3 and inserted into the primary set-top box 2. The primary smartcard 2 may have to be temporary removed from the primary set-top box 2 to enable this. Second activation data generated by the primary smartcard 2 is stored in the primary set-top box 2 prior to removing the primary smartcard 4 from the primary set-top box 2. When the secondary smartcard 5 is inserted into primary set-top box 2, the serial number of the secondary smartcard 5 is compared with the serial numbers received from the head-end system 1. If the serial number matches, then the secondary smartcard 5 is allowed to be activated by the primary set-top box 2. If furthermore the secondary smartcard 5 is initialized, the secondary smartcard 5 obtains the second activation data from the primary set-top box via the intermediary of the primary interface 21.

Next, the secondary smartcard 5 is removed from the primary set-top box 2 and inserted into the secondary set-top box 5. The primary smartcard 4 is inserted into the primary set-top box 2. The secondary smartcard 5 provides the second activation data to the secondary set-top box 3 through transmitter 54 and secondary interface 31. With the second activation data the secondary set-top box 3 is activated and ready to descramble scrambled TV signals.

In FIG. 3b the secondary smartcard 5 is inserted into the secondary set-top box 3. Primary set-top box 2 and secondary set-top box 3 are communicatively linked. In this exemplary embodiment the secondary smartcard 5 can remain inserted into the secondary set-top box 3. The second activation data is provided from the primary set-top box 2 to the secondary smartcard 5 via the communication link between primary and secondary set-top box and the secondary interface 31.

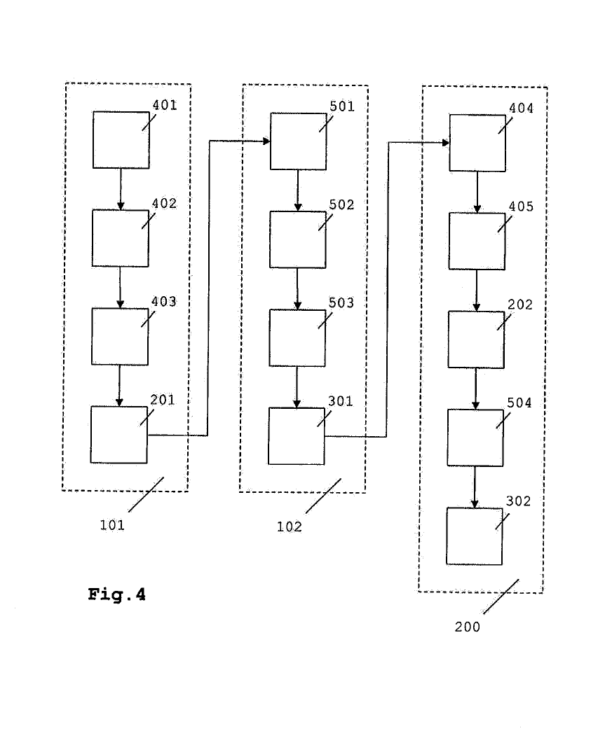

FIG. 4 shows the steps of activating one or more secondary set-top boxes 3 of an exemplary embodiment of the invention. The steps in block 101 are related to the activation of the primary set-top box 2. The steps in block 102 are related to the initialization of the secondary set-top box 3. The steps in block 200 are related to the activation of the secondary set-top box 3.

In step 401 the activation message is received from the head-end system 1 in the primary smartcard 4. In step 402 the primary smartcard 4 creates first activation data using the activation message. In step 403 the first activation data is provided to the primary set-top box 2 via the primary interface 21. In step 201 the primary set-top box 2 is activated using the first activation data.

In step 501 the initialization message is received from the head-end system 1 in the secondary smartcard 5. In step 502 the secondary smartcard 5 creates initialization data using the initialization message. In step 503 the initialization data is provided to the secondary set-top box 3 via the secondary interface 31. In step 301 the secondary set-top box 3 is initialized using the initialization data.

In step 404 the primary smartcard 4 creates second activation data. In step 405 the second activation data is provided to the primary set-top box 2 via the first interface 21. In step 202 the second activation data is provided to the secondary smartcard 5. In step 504 the second activation data is provided from the secondary smartcard 5 to the secondary set-top box 3 via the secondary interface 31. In step 302 the secondary set-top box 3 is activated using the second activation data.

FIG. 5 describes the function of optional first timer 41 within primary smartcard 4. First timer 41 is activated by the activation message received from the head-end system 1. After an amount of time—which is either provided in the activation message or predefined in the first timer 41—has lapsed, renewed second activation data is generated to be provided to the secondary smartcard 5 as described for FIG. 3a or FIG. 3b.

In step 401 the activation message is received from the head-end system 1 in the primary smartcard 4. From the activation message a first timer value is obtained, which is used to set the first timer 41 in step 405. The first timer value is e.g. the value 600, which is used to set first timer 41 to 600 seconds. In step 406 the first timer 41 is activated. In step 407 the first timer checks the status of the first timer 41. If 600 seconds have lapsed, renewed second activation data is provided to the secondary smartcard 5 and the first timer 41 is set to 600 seconds again.

FIG. 6 describes the function of optional second timer 51 within secondary smartcard 5. Second timer 51 is activated by the initialization message received from the head-end system 1. After an amount of time—which is either provided in the initialization message or predefined in the second timer 51—has lapsed, the secondary set-top box 3 is deactivated by the secondary smartcard 5. The secondary set-top box can be reactivated with renewed second activation data similar to the activation using second activation data as described for activation data in FIG. 3a or FIG. 3b.

In step 501 the initialization message is received from the head-end system 1 in the secondary smartcard 5. From the initialization message a second timer value is obtained, which is used to set the second timer 51 in step 505. The second timer value is e.g. the value 900, which is used to set second timer 51 to 900 seconds. In step 506 the second timer 51 is activated. In step 507 the second timer checks the status of the second timer 51. If 900 seconds have lapsed, the secondary decoder device 3 is deactivated until renewed second activation data is received. The renewed second activation data is e.g. received upon expiration of the first timer value in the first timer 41, as described for FIG. 5. In step 509 the secondary smartcard 5 checks whether or not the second activation data is received. Upon receipt of the second activation data, the secondary set-top box 3 is activated and the second timer 51 is set to 900 seconds again.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from appropriate consideration of the drawings, the disclosure, and the appended claims.

What is claimed is:

1. A method for activating one or more secondary decoder devices in a system, comprising:
a head-end system,
a primary decoder device, and
the one or more secondary decoder devices,
the head-end system being communicatively connected to the primary decoder device and to the one or more secondary decoder devices, the method comprising,
the head-end system activating the primary decoder device;
the head-end system initializing the secondary decoder device; and
the primary decoder device activating the initialized secondary decoder device,
wherein the primary decoder device comprises a primary interface configured for communication with a primary smartcard and the secondary decoder device comprises a secondary interface configured for communication with a secondary smartcard, the method further comprising,
receiving in the primary smartcard an activation message from the head-end system, creating in the primary smartcard first activation data using the activation message, providing the first activation data via the primary interface to the primary decoder device, and activating the primary decoder device using the first activation data;
receiving in the secondary smartcard an initialization message from the head-end system, creating in the secondary smartcard initialization data using the initialization message, providing the initialization data via the secondary interface to the secondary decoder device, and initializing the secondary decoder device using the initialization data;
creating in the primary smartcard second activation data and providing the second activation data via the first interface to the primary decoder device;
providing the second activation data from the primary decoder device to the secondary smartcard; and
providing the second activation data from the secondary smartcard via the secondary interface to the secondary decoder device, and activating the secondary decoder device using the second activation data,
and wherein the primary smartcard comprises a first timer, and wherein the method further comprises setting the first timer using a first timer value comprised in the activation message, activating the first timer, and upon expiration of the first timer value providing renewed second activation data from the primary decoder device to the secondary smartcard.

2. The method according to claim 1, wherein the primary interface is further configured for communication with the secondary smartcard, and wherein providing the second activation data from the primary decoder device to the secondary smartcard through the primary interface.

3. The method according to claim 1, wherein the primary decoder device is communicatively connected to the secondary decoder device, and providing the second activation data from the primary decoder device to the secondary smartcard through a communication link between the primary decoder device and the secondary decoder device.

4. The method according to claim 1, wherein the secondary smartcard comprises a second timer, and wherein the method further comprises,
setting the second timer using a second timer value comprised in the initialization message,
activating the second timer, and upon expiration of the second timer value deactivating the secondary decoder device until the renewed second activation data is received in the secondary smartcard.

5. A system comprising:
a head-end system for activating one or more secondary decoder devices in a system comprising the head-end system,
a primary decoder device comprising a primary interface configured for communication with a primary smartcard, and
the one or more secondary decoder devices comprising a secondary interface configured for communication with one or more secondary smartcards, the head-end system being communicatively connected to the primary decoder device and to the one or more secondary decoder devices, the head-end system comprising,
a smartcard management module configured for associating the one or more secondary smartcards with the primary smartcard;
an activation module configured for activating the primary decoder device by providing an activation message to the primary smartcard; and
an initialization module configured for initializing the secondary decoder device by providing an initialization message to the secondary smartcard,
wherein the activation message comprises a first timer value for setting a first timer in the primary smartcard, and wherein the initialization message comprises a second timer value for setting a second timer in the secondary smartcard.

6. A secondary smartcard for use in a system, comprising:
a head-end system,
a primary decoder device comprising a primary interface configured for communication with a primary smartcard, and
one or more secondary decoder devices, the secondary decoder device comprising a secondary interface configured for communication with the secondary smartcard, the secondary smartcard comprising,
a receiver configured for receiving an initialization message from the head-end system, the receiver further configured for receiving activation data from the primary smartcard via the intermediary of the primary decoder device;
a processor configured for creating initialization data using the initialization message;
a transmitter configured for providing the initialization data via the secondary interface to the secondary decoder device for initializing the secondary decoder device, the transmitter further configured for providing the activation data via the secondary interface to the secondary decoder device for activating the secondary decoder device,
further comprising a timer, and wherein the processor is further configured for setting the timer using a timer value comprised in the initialization message and for activating the timer, and wherein the secondary smartcard is configured for deactivating the secondary decoder device upon expiration of the second timer value until a renewed second activation data is received from the primary smartcard.

7. The secondary smartcard according to claim 6, wherein the receiver is configured for receiving the activation data from the primary smartcard via the intermediary of the primary decoder device through the primary interface.

8. The secondary smartcard according to claim 6, wherein the receiver is configured for receiving the activation data from the primary smartcard via the intermediary of the primary decoder device through a communication link between the primary decoder device and the secondary decoder device and the secondary interface.
